(19) United States
(12) Patent Application Publication
(10) Pub. No.: US 2026/0287391 A1
(43) Pub. Date: Sep. 24, 2026

(54) METHOD AND DEVICE FOR UPDATING NAVIGATION MAP INFORMATION

(71) Applicants: HYUNDAI MOTOR COMPANY, Seoul (KR); KIA CORPORATION, Seoul (KR)

(72) Inventors: Shi Do Lee, Hwaseong-si (KR); Tae Won Kim, Hwaseong-si (KR); Ho Joong Kim, Hwaseong-si (KR); Chi Heon Song, Hwaseong-si (KR)

(73) Assignees: HYUNDAI MOTOR COMPANY, Seoul (KR); KIA CORPORATION, Seoul (KR)

(21) Appl. No.: 19/307,603

(22) Filed: Aug. 22, 2025

(30) Foreign Application Priority Data
Mar. 19, 2025 (KR) 10-2025-0035368

(51) Int. Cl. G01C 21/00

(52) U.S. Cl. CPC G01C 21/3889; G01C 21/3896

(57) ABSTRACT

A method and a device update navigation map information. A method for updating map information by a terminal for providing navigation includes transmitting, to a server, a request signal that requests a tile required to update and display the map information when the map information needs to be updated on a navigation screen on which one or more tiles obtained by segmenting the map information into predetermined regional units, are combined and displayed. The method further includes receiving a response signal from the server in response to the request signal and updating a cache storing the map information, based on the response signal. The request signal includes the identifier (ID) of the required tile.

### CROSS-REFERENCE TO RELATED APPLICATION(S)

This application claims the benefit of and priority under 35 U.S.C. 119 to Korean Patent Application No. 10-2025-0035368, filed on Mar. 19, 2025, in the Korean Intellectual Property Office, the disclosure of which is incorporated herein in its entirety by reference.

### BACKGROUND OF THE DISCLOSURE

### Field of the Disclosure

The present disclosure relates to smart mobility. More specifically, the present disclosure relates to a method and a device for automatically updating navigation map information.

### Background

Navigation services have been shifting from offline map data to online real-time map data. This shift has significantly improved the real-time nature of map data. However, vehicle terminals must continuously download the latest data from a server, thereby causing an increase of data transmitted via a communications network. In this process, from a server operation perspective, increase in bandwidth usage in the communications network for data downloads is a technical problem.

Existing methods inevitably increase the amount of data downloaded, thereby increasing service operation requirements.

### SUMMARY OF THE DISCLOSURE

An aspect of the disclosed embodiments is to provide a technical solution for updating navigation map information while optimizing the amount of data downloaded and reducing service operation requirements.

Another aspect of the disclosed embodiment is to provide a technical solution for applying logic for asynchronously updating navigation map information and thereby updating the navigation map information without the user being aware of the update.

The technical features of various embodiments set forth herein may not be limited to the above-mentioned technical features. Other technical features which are not mentioned herein should be clearly understood from the following description by those of ordinary skill in the art.

According to various embodiments for realizing the above-described aspects, a method for updating map information includes transmitting, to a server by a terminal for providing navigation, a request signal configured to request a tile configured to update and display the map information based on the map information needing to be updated on a navigation screen on which one or more tiles obtained by segmenting the map information into predetermined regional units, are combined and displayed. The method further includes receiving, by the terminal, a response signal from the server in response to transmitting the request signal and updating a cache of the terminal storing the map information based on the response signal. The request signal includes an identifier (ID) of the required tile.

Based on a tile stored in the server being identical to a tile stored in the terminal, the response signal may include data having an empty body.

Based on a tile stored in the server being different from a tile stored in the terminal, the response signal may have a body including tile data for updating the cache of the terminal.

The request signal may be transmitted using Hypertext Transfer Protocol (HTTP).

Each tile may be formed as a separate file.

Requesting of the tile from the server may include generating a request signal for requesting the tile from the server, pushing the request signal into a queue in the terminal, and sequentially popping request signals stored in the queue and transmitting the request signals to the server.

The request signal may further include a hash value of the required tile.

Different hash values may be assigned to different tiles.

The hash value may be generated by a hash function.

The hash function may be a Message-Digest algorithm 5 (MD5) function.

According to a disclosed embodiment, a terminal installed in a vehicle to provide navigation includes a communication unit configured to transmit, to a server, a request signal configured to request a tile required to update and display map information based on the map information needing to be updated on a navigation screen on which one or more tiles obtained by segmenting the map information into predetermined regional units, are combined and displayed. The communication unit is configured to receive a response signal from the server in response to transmitting the request signal. The terminal further includes a processor configured to update a cache of the terminal storing the map information based on the response signal. The request signal includes an identifier (ID) of the required tile.

Based on a tile stored in the server being identical to a tile stored in the terminal, the response signal may be data having an empty body.

Based on a tile stored in the server being different from a tile stored in the terminal, the response signal may have a body including tile data for updating the cache of the terminal.

The request signal may be transmitted using Hypertext Transfer Protocol (HTTP).

The hash function may be a Message-Digest algorithm 5 (MD5) function.

The disclosed embodiments provide a technical solution to a technical problem by updating navigation map information while optimizing the amount of data downloaded and reducing service operation requirements.

In addition, the disclosed embodiments provide a technical solution for applying logic for asynchronously updating navigation map information, thereby updating the navigation map information without the user being aware of the update.

The technical solutions provided by the embodiments set forth herein are not limited to the above-mentioned effects. Other effects which are not mentioned herein may be clearly understood from the following description by those of ordinary skill in the art to which the embodiments pertain.

### BRIEF DESCRIPTION OF THE DRAWINGS

FIG. 1 is a block diagram schematically illustrating a map information update system according to an embodiment;

FIG. 2 is a block diagram illustrating different hash values being generated for different tiles according to an embodiment;

FIG. 3 is a diagram illustrating a request signal being transmitted from a terminal to a server and a response signal being transmitted from the server to the terminal according to an embodiment;

FIG. 4 is a flowchart illustrating a terminal's operations for updating navigation map information according to an embodiment;

FIG. 5 is a flowchart illustrating a server's operations for updating navigation map information according to an embodiment; and

FIG. 6 is a sequence diagram illustrating a method for updating map information by a map information update system according to another embodiment.

### DETAILED DESCRIPTION

A specific structural or functional description of various embodiments of the disclosure set forth in the present specification is provided for the purpose of describing various embodiment according to the present disclosure. Therefore, the embodiments according to the present disclosure may be implemented in various forms. The present disclosure should not be construed as being limited to the embodiments described in the specification.

Various changes and modifications may be made to the embodiments according to the present disclosure. Various embodiments are illustrated in the drawings and described in the specification. However, a person of ordinary skill in the art should understand that embodiments according to the present disclosure are not limited to the particular embodiments. However, the present disclosure includes various modifications, equivalents, and alternatives falling within the spirit and scope of the present disclosure.

Unless defined otherwise, all terms used herein, including technical and scientific terms, have the same meaning as those commonly understood by a person of ordinary skill in the art to which the present disclosure pertains. Such terms as those defined in a generally used dictionary may be interpreted to have the meanings equal to the contextual meanings in the relevant field of art, and should not be interpreted to have ideal or excessively formal meanings unless clearly defined in the present disclosure.

Hereinafter, embodiments set forth herein are described in detail with reference to the accompanying drawings. In the following drawings, the same reference numerals are used throughout to designate the same or equivalent elements, even though the elements are shown in different drawings.

As used in the following description of embodiments, the term “predetermined” refers to, when a parameter is used in a process or algorithm, the value of the parameter has previously been determined. The numerical value of the parameter may be set at the beginning of the process or algorithm or during an interval when the process or algorithm is performed.

The terms “module” and “unit” used for the elements in the following description are given or interchangeably used in consideration of only the ease of writing the specification, and do not have distinct meanings or roles by themselves. When a component, device, element, part, unit, module or the like of the present disclosure is described as having a purpose or performing an operation, function, or the like, the component, device, or element should be considered herein as being “configured to” meet that purpose or to perform that operation or function. Each “part”, “unit”, “module”, “component”, “device”, “element”, and the like may separately embody or be included with a processor and a memory, such as a non-transitory computer readable media, as part of the apparatus.

In describing the embodiments set forth herein, a detailed description of known functions or configurations incorporated herein is omitted when it is determined that the description may make the subject matter of the embodiments set forth herein unclear. In addition, it should be appreciated that the accompanying drawings are provided for understanding of the embodiments set forth herein. The technical idea of the present disclosure is not limited to the accompanying drawings and includes all modifications, equivalents, or alternatives falling within the spirit and scope of the present disclosure.

Terms including an ordinal number such as “a first” and “a second” may be used to describe various elements, but the elements are not limited to the terms. The above terms are used merely for the purpose of distinguishing one element from other elements.

When an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

A singular expression may include a plural expression unless it is used in a different context.

As used herein, the expression “include”, “comprise”, or “have” is intended to specify the existence of mentioned features, numbers, steps, operations, elements, components, or combinations thereof, and should be construed as not precluding the possible existence or addition of one or more other features, numbers, steps, operations, elements, components, or combinations thereof.

Throughout the disclosure, the term “body” refers to an “HTTP body”. In particular, the term “body” refers to an optional part of an HTTP message (a request or response) that carries the main content or data being transmitted. Further, an “empty body” refers to an empty HTTP body. In particular, the “empty body” refers to an HTTP message (a request or response) that includes a message body including zero length of data.

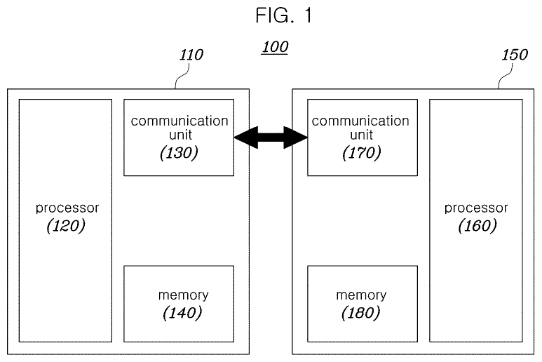

FIG. 1 is a diagram schematically illustrating a configuration of a map information update system according to an embodiment.

Referring to FIG. 1, a map information update system 100 according to the present embodiment includes a terminal 110 and a server 150.

The terminal 110 may be an in-vehicle infotainment (IVI) navigation installed in a vehicle. The terminal 110 includes a processor 120, a communication unit 130, and a storage unit or memory 140.

The processor 120 displays, on a navigation screen, a combination of one or more tiles obtained by segmenting map information into predetermined regional units.

The tiles may be rectangular segments of equal areas on a map.

Each tile may be identified by a corresponding identifier (ID).

The tiles may be preassigned different hash values.

Each tile may be implemented in a separate file.

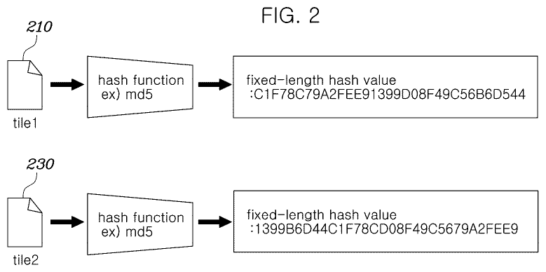

For example, referring to FIG. 2, different hash values may be assigned for different tiles including a first tile 210 and a second tile 230 and may be placed in front of the binaries of the tiles.

The hash values may be generated by a hash function, and, in an embodiment, Message-Digest algorithm 5 (MD5) may be used as the hash function.

In an embodiment, the hash values of the first tile 210 and the second tile 230 may be hexadecimal numbers with a fixed length of 32 characters.

In other words, the hash values of the first tile 210 and the second tile 230 may be 128-bit numbers.

The hash values may be extracted by reading only the length of corresponding offsets within the files corresponding to the tiles when the files are downloaded. The hash values may be used for tile version checking in addition to integrity verification.

In addition, simple integrity verification may be performed by comparing the hash values.

When a map region on the navigation screen needs to be updated, the processor 120 generates a request signal, which requests the transmission of a tile required to update and display the map on the navigation screen. The processor pushes the request signal into a queue in the memory 140.

The map region on the navigation screen is configured to be updated based on determining that any one of a plurality of predefined conditions/events has occurred. The plurality of conditions/events may include any one of a vehicle having moved to a new region, a user having scrolled a map location on the navigation screen, or the user having zoomed in or out on the navigation screen.

When the tiles do not exist in a cache, the processor 120 may generate a request signal, based solely on the ID of each tile.

When the tiles exist in the cache, the processor 120 may generate the request signal, based on the ID of each tile and the hash value of each tile.

When a signal identical to the generated request signal already exists in the queue, i.e., when a request signal corresponding to the same tile's ID already exists in the queue, the processor 120 may discard the request signal without pushing the request signal into the queue.

The processor 120 identifies whether tiles required to asynchronously display the map on the navigation screen are present in the cache within the memory 140. The processor 120 loads tiles existing in the cache to display the tiles on the screen.

When tiles do not exist in the cache, the processor 120 loads an offline map from the memory 140 and displays the offline map on the screen.

The processor 120 sequentially outputs a request signal stored in the queue and asynchronously transmits the request to the server 150 by using the communication unit 130.

In relation to the request signal, multiple signal transmissions may be simultaneously performed by a multithreading operation.

The request signal may be transmitted using Hypertext Transfer Protocol (HTTP).

The request signal transmitted to the server 150 may include the IDs and hash values of the tiles.

When the tiles are downloaded from the server 150, the processor 120 stores the downloaded tiles in the cache.

The communication unit 130, under the control of the processor 120, transmits to the server 150, a request signal which requests the server 150 to check whether the tiles displayed on the screen of the terminal 110 are the latest version, and receives a response signal in response. In an embodiment, the communication unit 130 be implemented by the processor 120. The communication unit 130 may include a communication interface including a physical connection in hardware.

The memory 140 stores information about a tile to be displayed on the navigation screen, a request signal to be transmitted to the server, and a response signal received from the server.

The memory 140 may include a cache.

The server 150 may be a content distribution network (CDN) server. The server 150 includes a processor 160, a communication unit 170, and a storage unit or memory 180.

When a request signal for transmission of a tile is received from the terminal 110, the processor 160 determines whether a hash value corresponding to the ID of the tile in the request signal matches a hash value corresponding to the ID of the tile in the memory 180.

When there is no hash value in the request signal, the processor 160 may determine that the hash value corresponding to the ID of the tile in the request signal does not match the hash value corresponding to the ID of the tile in the memory 180.

As a result of the determination, when the hash value corresponding to the ID of the tile in the request signal matches the hash value corresponding to the ID of the tile in the memory 180, the processor 160 determines that the tile is the latest version, and transmits, to the terminal 110, a response signal indicating that the tile is the latest version.

The response signal may include data having an empty body.

The response signal may include an HTTP status code 304 having an empty body.

On the other hand, as a result of the determination, when the hash value corresponding to the ID of the tile in the request signal does not match the hash value corresponding to the ID of the tile in the memory 180, the processor 160 determines that the tile is not the latest version, and transmits, to the terminal 110, a response signal indicating that the tile is not the latest version.

The response signal may have a body including tile data for updating the cache of the terminal.

The response signal may include an HTTP status code 200 containing the latest version of the tile.

The communication unit 170, under control of the processor 160, receives a request signal for transmission of a tile from the terminal 110 and transmits a response signal in response to the request signal. In an embodiment, the communication unit 170 may be implemented by the processor 160. The communication unit 170 may include a communication interface including a physical connection in hardware.

The response signal may include an HTTP status code 304 having an empty body, or an HTTP status code 200 having a body that contains the latest version of the tile.

The memory 180 stores map data to be displayed on a vehicle's navigation screen.

The map data stored in the storage unit or memory 180 may be the latest map data.

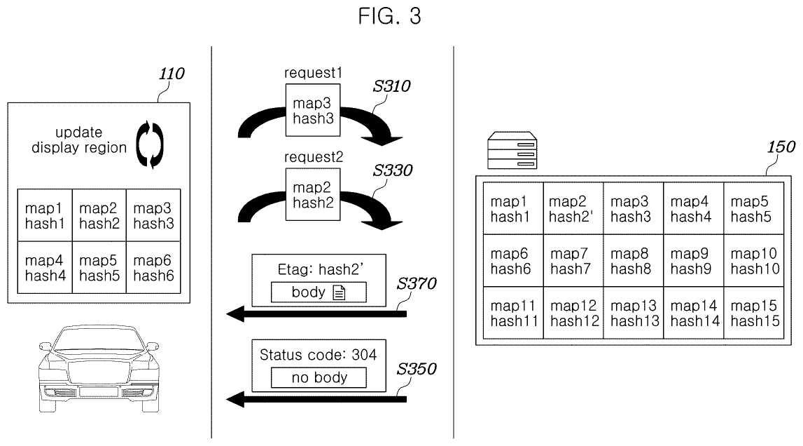

FIG. 3 is a diagram illustrating a request signal being transmitted from the terminal 110 to the server 150, and a response signal being transmitted from the server 150 to the terminal 110, according to an embodiment.

In an embodiment, referring to FIG. 3, as the display region of a navigation screen is updated while the vehicle is traveling, the terminal 110 may transmit a first request signal, which requests a third tile, to the server 150 (S310). The terminal 110 may transmit a second request signal, which requests a second tile, to the server 150 (S330).

For example, the ID of the third tile may be defined as map 3 and the hash value of the third tile may be defined as hash 3.

Also, the ID of the second tile may be defined as map 2 and the hash value of the second tile may be defined as hash 2.

The server 150 may store a new hash value, hash 2′, for the hash value of the second tile, and may store hash 3, for the hash value of the third tile, which is the same as the hash value stored in the terminal 110.

Thus, in response to the first request signal, the server 150 may transmit, to the terminal 110, a first response signal which has a header, containing “304 Not modified” header data, and an empty body (S350). In response to the second request signal, the server 150 may transmit to the terminal 110, a second response signal which has a header containing a new hash value, hash 2′, and a body containing updated map information (S370). The second response signal may transmit the new hash value to the terminal 110 by using an Entity Tag (ETag).

Cache control via ETag, which operates in a browser, may be used in the same way in the terminal 110, thereby optimizing data download capacity.

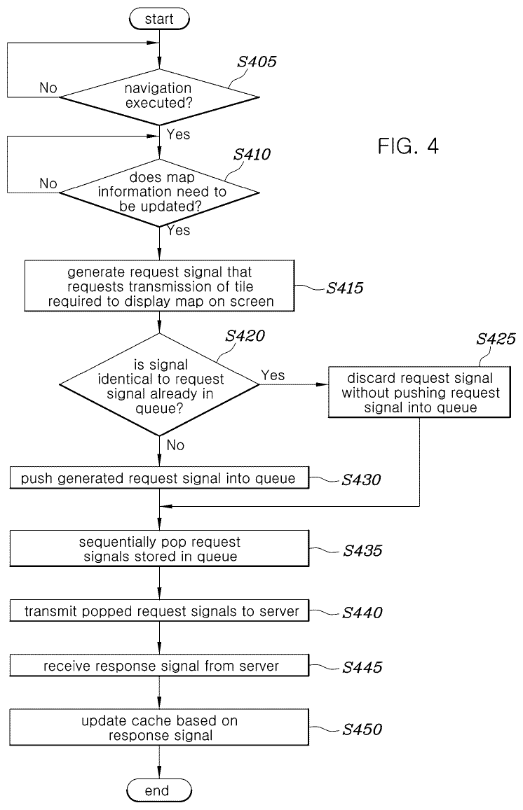

FIG. 4 is a flow chart illustrating operations performed by the terminal 110 to update navigation map information according to an embodiment.

An update method according to an embodiment may be performed by the terminal 110 in the embodiment of FIG. 1.

Referring to FIG. 4, when navigation is executed (YES in S405), the terminal 110 determines whether map information needs to be updated on a navigation screen (S410).

The map information needs to be updated on the navigation screen upon determining that any one of a plurality of events occur. The plurality of events may include a vehicle having moved to a new region, a user having scrolled a map location on the navigation screen, or the user being zoomed in or out on the navigation screen.

As a result of the determination, YES in operation S410, when a map region on the navigation screen needs to be updated, the terminal 110 generates a request signal for requesting tiles, which are required to update the map region, from the server 150 (S415).

When tiles required to display a map on the navigation screen do not exist in a cache, the request signal may be generated based solely on the ID of each tile.

When the required tiles exist in the cache, the request signal may be generated based on the ID of each tile and the hash value of each tile.

Furthermore, the terminal 110 determines whether a signal identical to the request signal generated in operation S415 already exists in a queue (S420). In other words, the terminal 110 determines whether a request signal corresponding to the ID of the same tile already exists in the queue.

As a result of the determination in operation S420, when a request signal identical to the request signal generated in operation S415 already exists in the queue (YES in S420), the request signal is discarded without being pushed to the queue (S425).

As a result of the determination in operation S420, when a request signal identical to the request signal generated in operation S415 does not exist in the queue (NO in S420), the request signal generated in operation S415 is pushed into the queue (S430).

Furthermore, the terminal 110 sequentially pops, i.e., retrieves, a request signal stored in the queue (S435) and transmits the sequentially popped request signal to the server 150 (S440).

The request signal may be transmitted asynchronously.

In relation to the request signal, multiple signal transmissions may be carried out simultaneously through a multithreading operation.

The request signal may be transmitted using the Hypertext Transfer Protocol (HTTP).

The request signal transmitted to the server 150 may include the ID and hash value of a tile.

The terminal 110 receives a response signal from the server 150 (S445) and updates, based on the received response signal, the cache in which the map information is stored (S450).

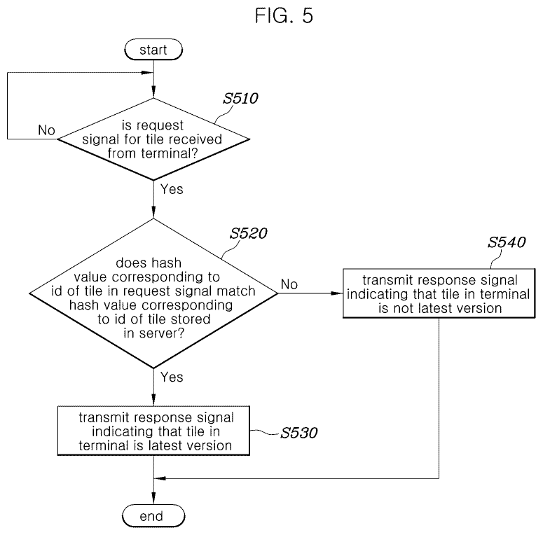

FIG. 5 is a flow chart illustrating operations performed by the server 150 to update navigation map information according to an embodiment.

An update method according to the present embodiment may be performed by the server 150 in the embodiment of FIG. 1.

Referring to FIG. 5, the server 150 determines whether a request signal for a tile has been received from the terminal 110 (S510). When the request signal has been received (YES in S510), the server 150 determines whether a hash value corresponding to the ID of a tile in the request signal matches a hash value corresponding to the ID of the tile in the memory 180 (S520).

As a result of the determination in operation S520, when the hash value corresponding to the ID of the tile in the request signal matches the hash value corresponding to the ID of the tile stored in the server 150 (YES in S520), a response signal indicating that the tile is the latest version is transmitted to the terminal 110 (S530).

The response signal indicating that the tile is the latest version may be an HTTP status code 304 having an empty body.

On the other hand, as a result of the determination in operation S520, when the hash value corresponding to the ID of the tile in the request signal does not match the hash value corresponding to the ID of the tile in the memory 180 (NO in S520), a response signal indicating that the tile is not the latest version is transmitted to the terminal 110 (S540).

The response signal indicating that the tile is not the latest version may include an HTTP status code 200 having a body containing the latest version of the tile.

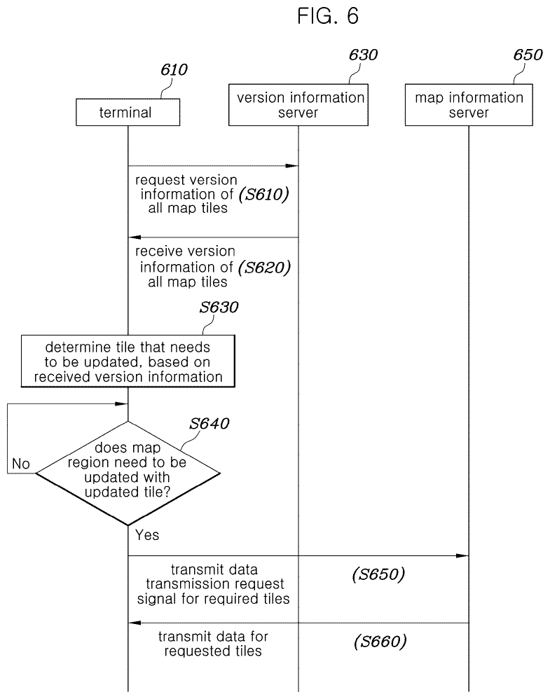

FIG. 6 shows a flow chart schematically illustrating a method for updating map information by a map information update system according to another embodiment.

Referring to FIG. 6, a terminal 610 requests version information of all map tiles from a version information server 630 (S610). The terminal 610 receives the version information of all map tiles from a version information server 630 in response to the request (S620).

Furthermore, the terminal 610 determines which tile needs to be updated, based on the version information received from the version information server 630 (S630).

The terminal 610 determines whether a map region needs to be updated with updated tile on a navigation screen (S640).

The map region needs to be updated with updated tiles on the navigation screen when a plurality of events occurs. The plurality of events may include any one of a vehicle has moved to a new region, a user has scrolled a map location on the navigation screen or the user has zoomed in or out on the navigation screen.

As a result of the determination in operation S640, when it is determined that the map region needs to be updated with the updated tile (YES in S640), the terminal 610 transmits a data transmission request signal for required tiles to a map information server 650 (S650).

Furthermore, in response to the data transmission request signal received from the terminal 610, the map information server 650 transmits data for the tiles requested in the data transmission request signal to the terminal 610 (S660).

The embodiments described above provide a technical solution for updating navigation map information while optimizing the amount of data downloaded and reducing service operation requirements.

Furthermore, the embodiments described above provide a technical solution for asynchronously applying logic for updating navigation map information, thereby updating the navigation map information without the user being aware of the update.

The present disclosure as described above may be implemented as codes or computer-executable instructions stored in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Therefore, the above detailed description should not be construed in a limitative sense but should be considered in an illustrative sense in all aspects. The scope of the embodiments set forth herein should not be determined solely by reasonable interpretation of the appended claims. All changes and modifications within the equivalent scope of the embodiments fall within the scope of the embodiments set forth herein.

What is claimed is:

1. A method for updating map information, the method comprising:
transmitting, to a server, by a terminal for providing navigation, a request signal configured to request a tile configured to update and display the map information based on the map information needing to be updated on a navigation screen on which one or more tiles obtained by segmenting the map information into predetermined regional units, are combined and displayed; and
receiving, by the terminal, a response signal from the server in response to transmitting the request signal and updating a cache of the terminal storing the map information based on the response signal,
wherein the request signal comprises an identifier (ID) of the required tile.

2. The method of claim 1, wherein based on a tile stored in the server being identical to a tile stored in the terminal, the response signal includes data having an empty body.

3. The method of claim 1, wherein based on a tile stored in the server being different from a tile stored in the terminal, the response signal has a body comprising tile data for updating the cache of the terminal.

4. The method of claim 1, wherein the request signal is transmitted using Hypertext Transfer Protocol (HTTP).

5. The method of claim 1, wherein each tile is included in a separate file.

6. The method of claim 1, wherein requesting the tile from the server comprises:
generating a request signal for requesting the tile from the server;
pushing the request signal into a queue in the terminal; and
sequentially popping request signals stored in the queue and transmitting the request signals to the server.

7. The method of claim 1, wherein the request signal further comprises a hash value of the required tile.

8. The method of claim 7, wherein different hash values are assigned to different tiles.

9. The method of claim 7, wherein the hash value is generated by a hash function.

10. The method of claim 9, wherein the hash function is a Message-Digest algorithm 5 (MD5) function.

11. A terminal for providing navigation, the terminal comprising:
a communication unit configured to transmit to a server, a request signal that requests a tile configured to update and display map information based on the map information needing to be updated on a navigation screen on which one or more tiles, obtained by segmenting the map information into predetermined regional units, are combined and displayed, and receive a response signal from the server in response to the transmittal of the request signal; and
a processor configured to update a cache of the terminal storing the map information based on the response signal,
wherein the request signal comprises an identifier (ID) of the required tile.

12. The terminal of claim 11, wherein based on a tile stored in the server being identical to a tile stored in the terminal, the response signal includes data having an empty body.

13. The terminal of claim 11, wherein based on a tile stored in the server being different from a tile stored in the terminal, the response signal has a body comprising tile data for updating the cache of the terminal.

14. The terminal of claim 11, wherein the request signal is transmitted using Hypertext Transfer Protocol (HTTP).

15. The terminal of claim 11, wherein each tile is formed as a separate file.

16. The terminal of claim 11, wherein the processor is configured to:
generate a request signal for requesting the tile from the server;
push the request signal into a queue in the terminal; and
sequentially pop request signals stored in the queue and transmit the request signals to the server.

17. The terminal of claim 11, wherein the request signal further comprises a hash value of the required tile.

18. The terminal of claim 17, wherein different hash values are assigned to different tiles.

19. The terminal of claim 17, wherein the hash value is generated by a hash function.

20. The terminal of claim 19, wherein the hash function is a Message-Digest algorithm 5 (MD5) function.
